(19) United States
(12) Patent Application Publication
(10) Pub. No.: US 2014/0034801 A1
(43) Pub. Date: Feb. 6, 2014

(54) OVER DOOR HANGER

(71) Applicant: Dong Koo Kim, Rowland Hts., CA (US)

(72) Inventor: Dong Koo Kim, Rowland Hts., CA (US)

(21) Appl. No.: 13/567,909

(22) Filed: Aug. 6, 2012

(51) Int. Cl. A47B 96/06; A47G 1/20; F16B 45/00

(52) U.S. Cl. 248/475.1; 248/225.21

(57) ABSTRACT

The claimed invention is a hanging system for hanging an object, such as a wardrobe mirror, over a door. The invention includes a door hook and an interlock plate. The interlock plate is secured to the object and the door hook is hooked over the top of a door. The interlock plate includes interlock clips that fit into and engage with apertures on the door hook. This configuration allows the user to quickly and easily assemble and disassemble the over door hanging system.

### FIELD OF THE INVENTION

The present invention relates generally to an over door hanger and/or an over door hanging system. More specifically, the invention is an over door hanging system for supporting a wardrobe mirror onto the face or back of a door.

### BACKGROUND OF THE INVENTION

Currently, over door wardrobe mirror hanging systems come in bulky preassembled hanging units or, where assembly is required, such assembly is time consuming and requires use of a number of tools. As a result, quick and easy disassembly is not possible with these products. Furthermore, currently available over door hanging mirror units do not allow for convenient height adjustment, which makes it difficult for shorter or taller persons to share the mirror.

Examples of currently available over door hanging mirrors include U.S. Pat. Nos. D385,481, issued to Klein and 6,854,610, issued to Adams. The Klein patent discloses an over the door hanger, wherein the portion that engages a mirror has two apertures that are symmetrically placed on a bent triangle that sticks out from the main part of the mirror hanger. FIG. 7 of Klein shows that the two apertures are designed to accept and engage with an interlocking and downward pointing hook that is passed through the two apertures to secure an object to the door hanger. The Adams patent discloses a door hook with a top bracket component and an object securing component that interlocks with the bracket component via a hook. The two components of the Adams reference are locked together by a tab or tooth in one component that fits into a slot, recess, or aperture, in a second component. Although the Klein and Adams Patents disclose a mirror hanging system that goes over a bedroom or bathroom door, these mirror hanging systems are not adjustable, are difficult to put together, and do not include an interlocking clip to secure the mirror in place and prevent the mirror from inadvertently becoming dislodged.

Thus, what is needed is a wardrobe mirror hanger device that overcomes the limitations of the prior art and that allows for quick and easy assembly and disassembly, the ability to adjust the height of the mirror, and that has an interlock clip to lock the two portions of the hanging system together.

### SUMMARY OF THE INVENTION

To minimize the limitations in the prior art, and to minimize other limitations that will become apparent upon reading and understanding the present specification, the present invention discloses a new and useful device for hanging an object, such as a wardrobe mirror, over a door.

One embodiment of the invention is a device for hanging an object over a door comprising: a door hook; and an interlock plate. The door hook is comprised of an upper bracket and an interlock plate engagement portion. The upper bracket is configured to engage a top of a door such that the door supports the door hook. The interlock plate engagement portion is comprised of one or more apertures. The interlock plate is configured to engage with an object and is comprised of one or more interlock clips. The one or more interlock clips are configured to matingly engage with the one or more apertures of the interlock plate engagement portion. Preferably, the interlock plate is further comprised of one or more securing apertures. Preferably, the one or more interlock clips extend outward from the interlock plate, such that when the interlock plate engages with the interlock plate engagement portion, at least one of the one or more interlock clips pass through at least of the one or more apertures of the interlock plate engagement portion. Preferably, the object is a mirror and there are three apertures on the interlock engagement portion and three interlock clips on the interlock plate.

Another embodiment of the present invention is a device for hanging an object over a door comprising: a door hook; and an interlock plate. The door hook is comprised of an upper bracket and an interlock plate engagement portion. The upper bracket is configured to engage a top of a door such that the door supports the door hook. The interlock plate engagement portion is comprised of one or more apertures. The interlock plate is configured to engage with an object and is comprised of one or more interlock clips. The interlock plate is further comprised of one or more securing apertures. The interlock plate engages with the interlock plate engagement portion. The one or more interlock clips extend outward from the interlock plate, such that when the interlock plate engages with the interlock plate engagement portion, at least one of the one or more interlock clips pass through at least of the one or more apertures of the interlock plate engagement portion, such that the one or more interlock clips matingly engage with the one or more apertures of the interlock plate engagement portion. The object may be a mirror, a toiletry kit, a shave rack, a tie rack, a suit rack, or any of a number of other objects that would be helpful to have hanging on a door in a bedroom, closet, or bathroom. Preferably, there are three apertures on the interlock engagement portion and there are three interlock clips on the interlock plate.

In another embodiment the invention is a device for hanging an object over a door comprising: a door hook; and an interlock plate. The door hook is comprised of an upper bracket and an interlock plate engagement portion. The upper bracket is configured to engage a top of a door such that the door supports the door hook, and the upper bracket is comprised of a front, a top, and a back. The interlock plate engagement portion is comprised of one or more apertures and the interlock plate engagement portion is an extension of the back of the upper bracket. The interlock plate is configured to engage with an object and is comprised of one or more interlock clips. The one or more interlock clips are configured to matingly engage with the one or more apertures of the interlock plate engagement portion. Preferably, the interlock plate is further comprised of one or more securing apertures. Preferably the one or more interlock clips extend outward and downward from the interlock plate, such that when the interlock plate engages with the interlock plate engagement portion, at least one of the one or more interlock clips pass through at least of the one or more apertures of the interlock plate engagement portion, and wherein the interlock plate slides downward such that the interlock plate and the object that is secured to the interlock plate are supported by the door hook. The object may be a mirror. Preferably, there are three apertures on the interlock engagement portion and three interlock clips on the interlock plate.

In a preferred embodiment the invention is a mirror hanger that is comprised of two parts: a door hook and an interlock plate. The door hook engages with the top, front and back of a door and hangs down the back or front of the door. The interlock plate is secured to a mirror, preferably with screws or a very strong adhesive. The interlock plate is then matingly engaged to the door hook by passing the interlock clips through holes in the door hook.

It is an object of the present invention to provide a hanging device for mirrors that hooks onto the top of a door.

It is an object of the present invention to provide an adjustable mirror hanger.

It is an object of the present invention to provide a mirror hanger that is durable, easy to use, inexpensive, and easy to manufacture.

It is an object of the present invention to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of the door hook of one embodiment of the hanger.

FIG. 2 is an illustration of a perspective view of the door hook of another embodiment of the hanger.

FIG. 3 is an illustration of a perspective view of the interlock plate of one embodiment of the hanger.

FIG. 4 is an illustration of a front plan view of the interlock plate of one embodiment of the hanger.

FIG. 5 is an illustration of a perspective view of one embodiment of the hanger and shows the interlock clips passing through the apertures of the door hook.

FIG. 6 is an illustration of a side plan view of one embodiment of the hanger and shows the hanger hanging from a door.

FIG. 7 is an illustration of a perspective view of one embodiment of the hanger and shows the interlock clips passing through the snap-lock apertures of the door hook.

FIG. 8 is an illustration of a side plan view of the door hook of another embodiment of the hanger.

FIG. 9 is an illustration of an obverse perspective view of the door hook of another embodiment of the hanger.

FIG. 10 is an illustration of a perspective view of the bracket of another embodiment of the hanger.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the figures, and the detailed descriptions thereof, are to be regarded as illustrative in nature and not restrictive. Also, the reference or non-reference to a particular embodiment of the invention shall not be interpreted to limit the scope of the invention.

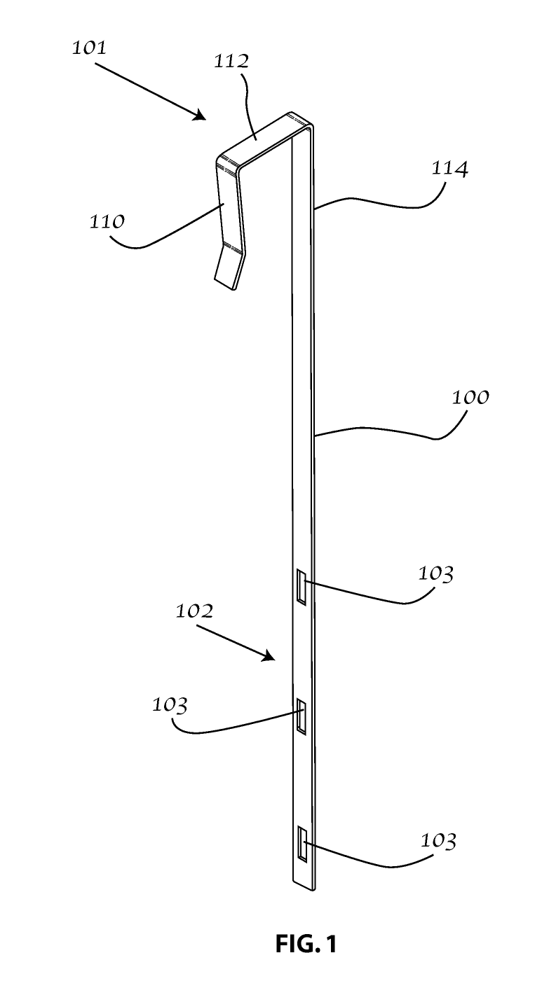

FIG. 1 is an illustration of a perspective view of the door hook of one embodiment of the hanger. As shown in FIG. 1 the door hook 100, which is preferably part of a device for hanging an object over a door, is comprised of a upper bracket 101 and an interlock plate engagement portion 102. The upper bracket 101 is preferably a bracket that has a front 110, top 112, and back 114, and is configured to engage with the top of a door. FIG. 1 also shows how the back 114 preferably extends to become the interlock plate engagement portion 102. FIG. 1 shows that the interlock plate engagement portion has one or more apertures 103, and preferably three apertures 103.

The door hook 100 is preferably a flat single piece of metal, such as steel or aluminum, which is bent such that it may engage with a standard household door. It should be understood that the door hook 100 may be made from any natural or man-made material, and may be in a variety of shapes, and may be constructed from more than one piece, without deviating from the scope of the invention.

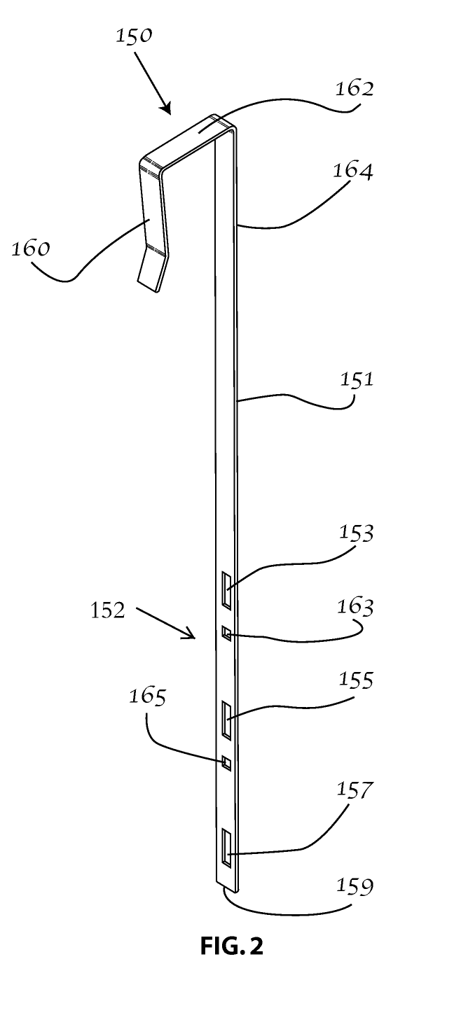

FIG. 2 is an illustration of a perspective view of the door hook of another embodiment of the hanger. As shown in FIG. 2 the door hook 151, which is preferably part of a device for hanging an object over a door, is comprised of a upper bracket 150 and an interlock plate engagement portion 152. The upper bracket 150 is preferably a bracket that has a front 160, top 112, and back 164, and is configured to engage with the top of a door. FIG. 2 also shows how the back 164 preferably extends to become the interlock plate engagement portion 152. FIG. 2 shows that the interlock plate engagement portion has one or more apertures 153, 155, and 157, and one or more snap-lock apertures 163 and 164. FIG. 2 also shows end 159.

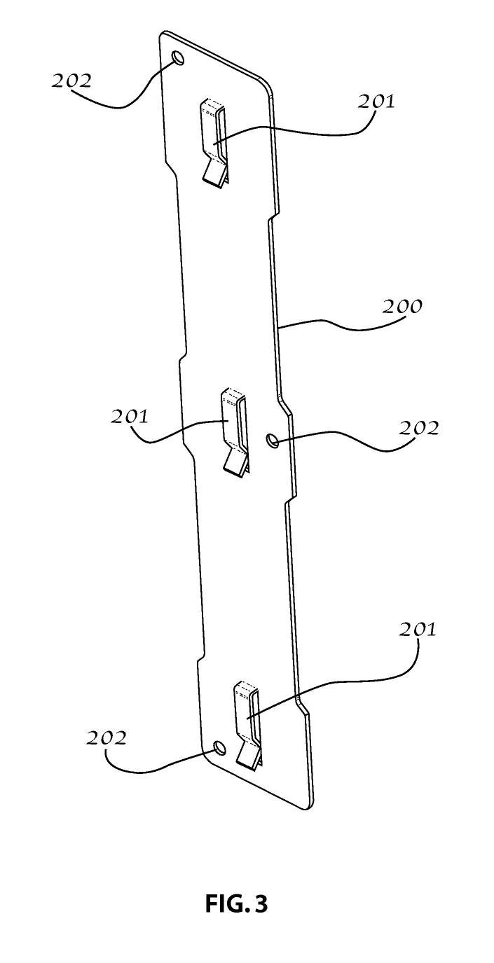

FIG. 3 is an illustration of a perspective view of the interlock plate of one embodiment of the hanger. As shown in FIG. 3 the interlock plate 200 is preferably comprised of one or more interlock clips 201 and one or more securing apertures 202. Preferably, the interlock plate 200 has three clips 201 and three apertures 202. FIG. 3 also shows how the interlock clips 202 extend outward and downward from the interlock plate 200. The interlock clips 202 are engagement portions are preferably configured to engage with apertures 103 of the door hook 100.

The interlock plate 200 is preferably a flat single piece of metal, such as steel or aluminum, wherein the which is bent such that it may engage with a standard household door. It should be understood that the interlock plate 200 may be made from any natural or man-made material, and may be in a variety of shapes, and may be constructed from more than one piece, without deviating from the scope of the invention.

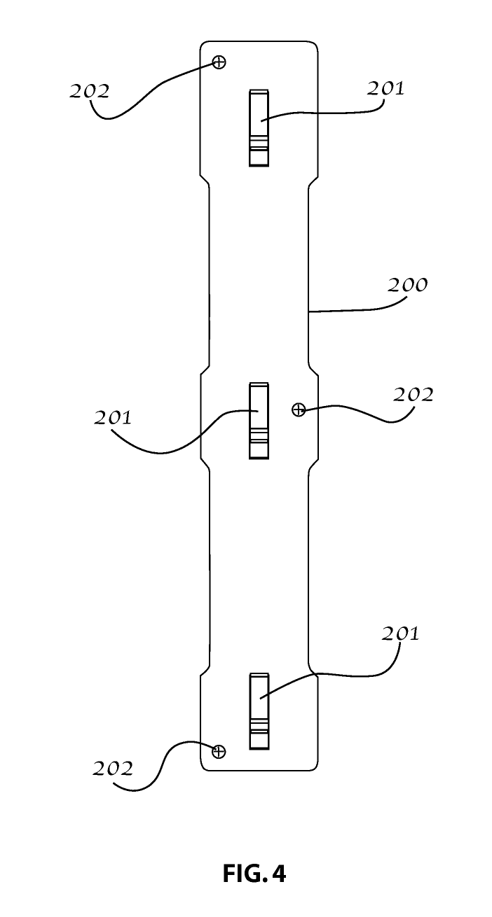

FIG. 4 is an illustration of a front plan view of the interlock plate of one embodiment of the hanger. As shown in FIG. 4 the interlock plate 200 is preferably comprised of one or more interlock clips 201 and one or more securing apertures 202.

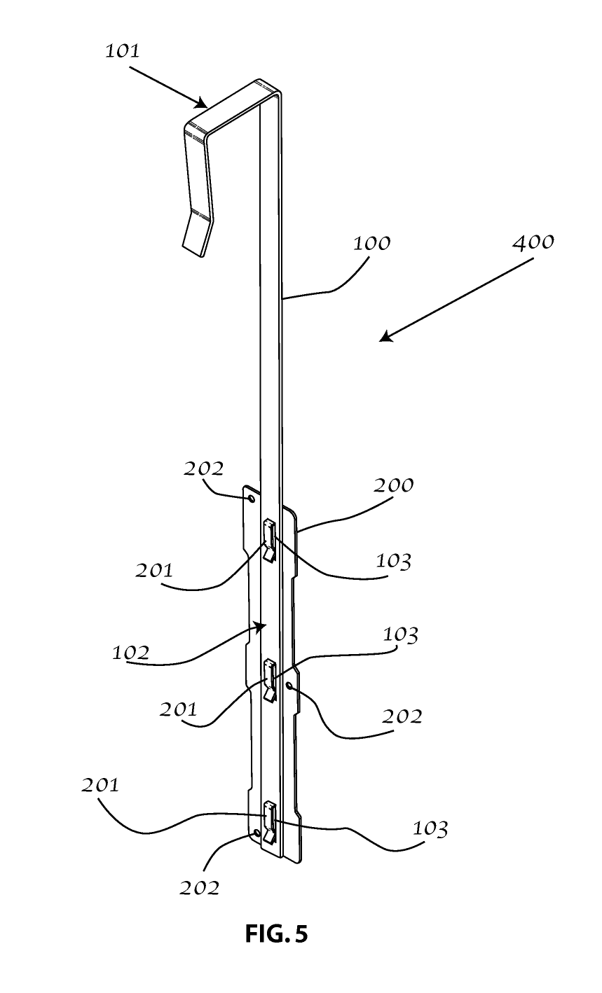

FIG. 5 is an illustration of a perspective view of one embodiment of the hanger and shows the interlock clips passing through the apertures of the door hook. FIG. 5 shows that the hanger is preferably comprised of door hook 100 and interlock plate 200. As shown in FIG. 5, the interlock clips 201 preferably matingly engage with the apertures 103 by passing through the apertures 103. The interlock plate 200 is then secured in place by pushing interlock plate 200 down until the base of the interlock clip 201 prevents the interlock plate 200 from going any further. FIG. 5 shows that the interlock clip 201 would press against the interlock engagement portion 102 and that friction would hold the interlock plate 200 and interlock engagement portion 102 from being inadvertently separated. Although FIG. 5 shows three interlock clips 201 engaging with apertures 103, it should be understood that there may be many more clips 201 and apertures 103. Furthermore, in order to adjust the interlock plate 200 downward, fewer interlock clips 201 may engage with fewer apertures. At least one interlock clip 201 should engage with at least one aperture 103. The more apertures 103 that are engaged, the more stable the hanger 400 is.

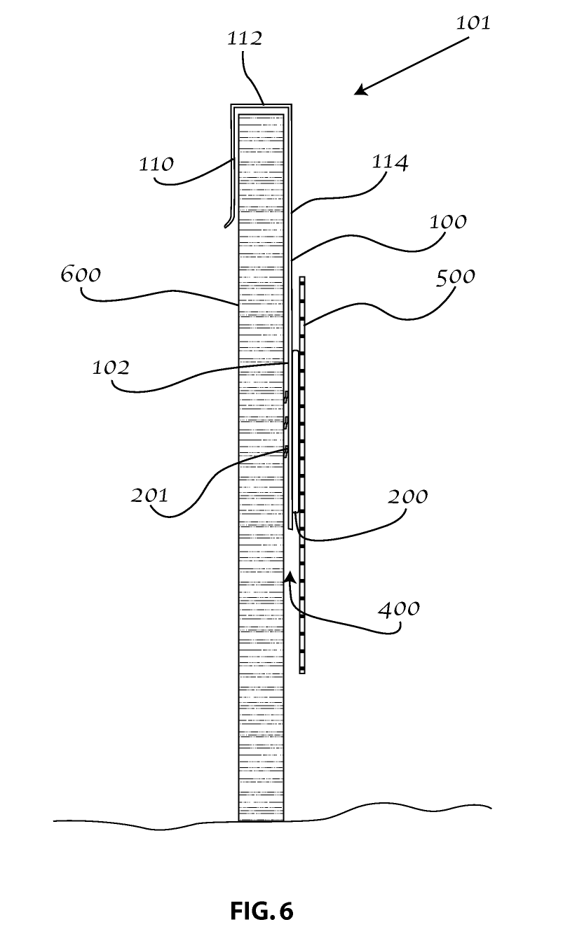

FIG. 6 is an illustration of a side view of one embodiment of the hanger and shows the hanger hanging from a door. As shown in FIG. 6, the interlock plate 200 of hanger 400 has been secured to mirror 500. FIG. 6 also shows that the interlock plate 200 is engaged with interlock plate engagement portion 102 of door hook 100, such that mirror 500 is hanging from door 600. As shown in FIG. 6, upper bracket 101 of door hook 100 includes front 110, top 112, and back 114 and matingly engages and hangs from door 600. The shape of upper bracket 101 is preferably determined by the shape of the door with which the hanger will engage. Although FIG. 6 shows that a mirror is hanged, it should be understood that mirror 600 may be any different objects which need to be hung, without deviating from the scope of the invention.

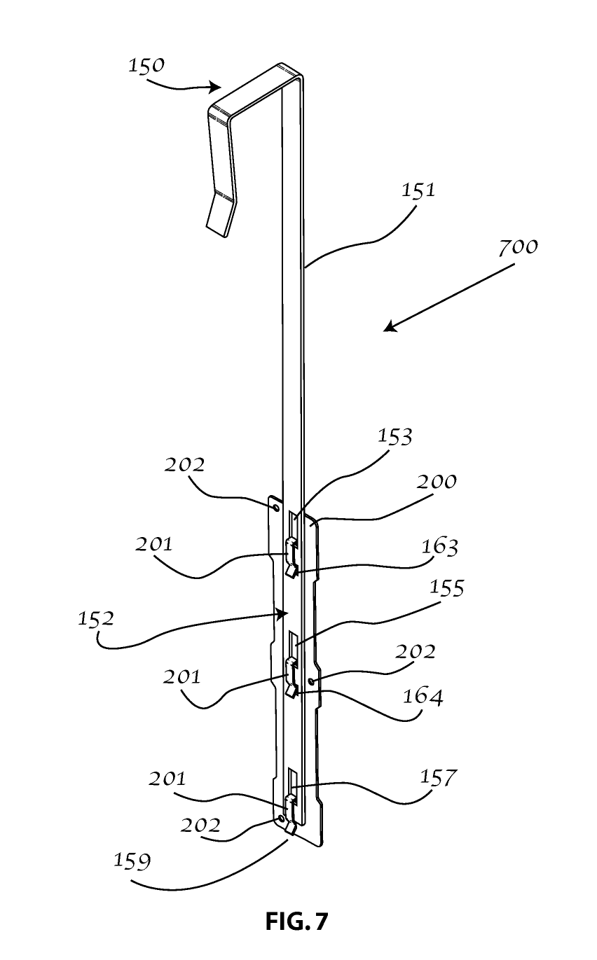

FIG. 7 is an illustration of a perspective view of one embodiment of the hanger and shows the interlock clips passing through the snap-lock apertures of the door hook. As shown in FIG. 7 the door hook 151, is comprised of an upper bracket 150 and an interlock plate engagement portion 152. FIG. 7 shows that the interlock plate engagement portion has one or more apertures 153, 155, and 157, and one or more snap-lock apertures 163 and 164.

As shown in FIG. 7, the interlock clips 201 preferably matingly engage with the apertures 153, 155, and 157, by passing through the apertures 153, 155, and 157. The interlock plate 200 is then secured in place by pushing interlock plate 200 down until the indented tab of the interlock clips 201 snap into place in snap-lock apertures 163 and 164. FIG. 7 shows how the indented tab of bottom interlock clip 201 may snap into place in end 159. This snap-lock system preferably secures the interlock plate 200 to the door hook 151 to prevent accidental slippage or separation.

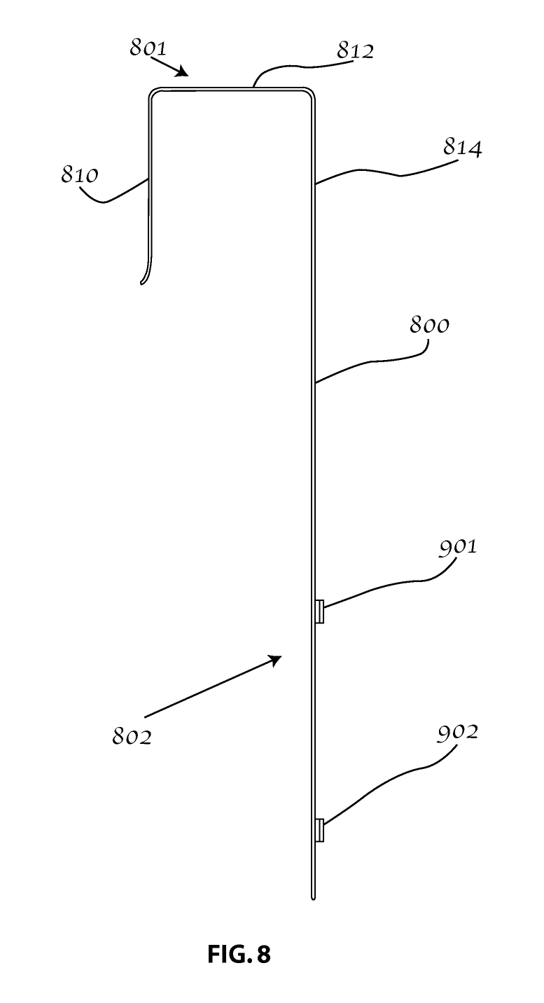

FIG. 8 is an illustration of a side plan view of the door hook of another embodiment of the hanger. As shown in FIGS. 8-10, in another embodiment the door hook may have the interlock clip and the interlock plate may have the apertures. As shown in FIG. 8, the door hook 800, which is preferably part of a device for hanging an object over a door, is comprised of a upper bracket 801 and an interlock plate engagement portion 802. The upper bracket 801 is preferably a bracket that has a front 810, top 812, and back 814, and is configured to engage with the top of a door. FIG. 8 also shows how the back 814 preferably extends to become the interlock plate engagement portion 802. FIG. 1 shows that the interlock plate engagement portion 802 has one or more tabs 901 and 902.

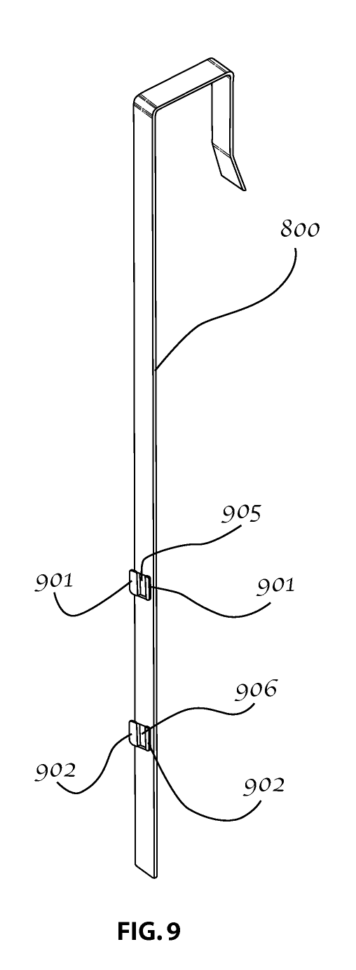

FIG. 9 is an illustration of an obverse perspective view of the door hook of another embodiment of the hanger. FIG. 9 shows that the interlock plate engagement portion 802 has one or more tabs 901 and 902. FIG. 9 shows how, in a preferred embodiment, the tabs 901 and 902 frame apertures 905 and 906.

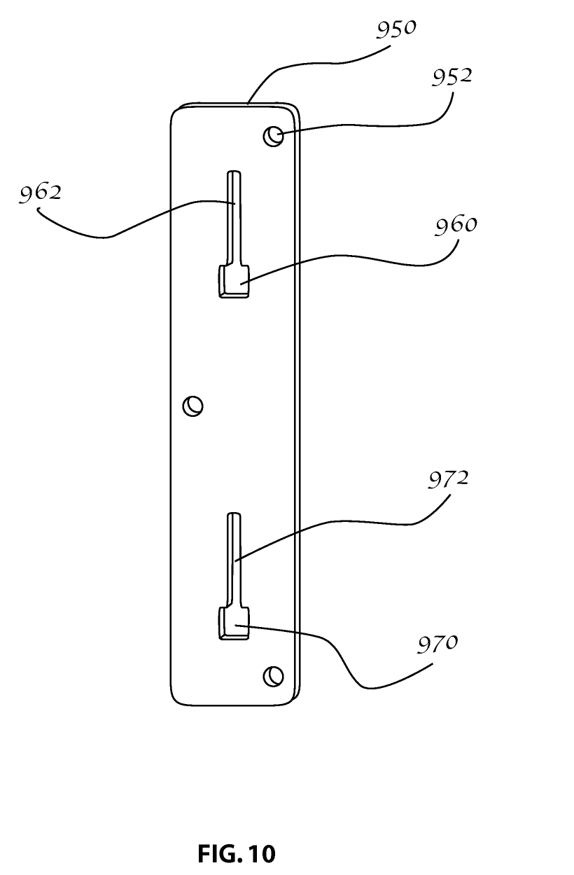

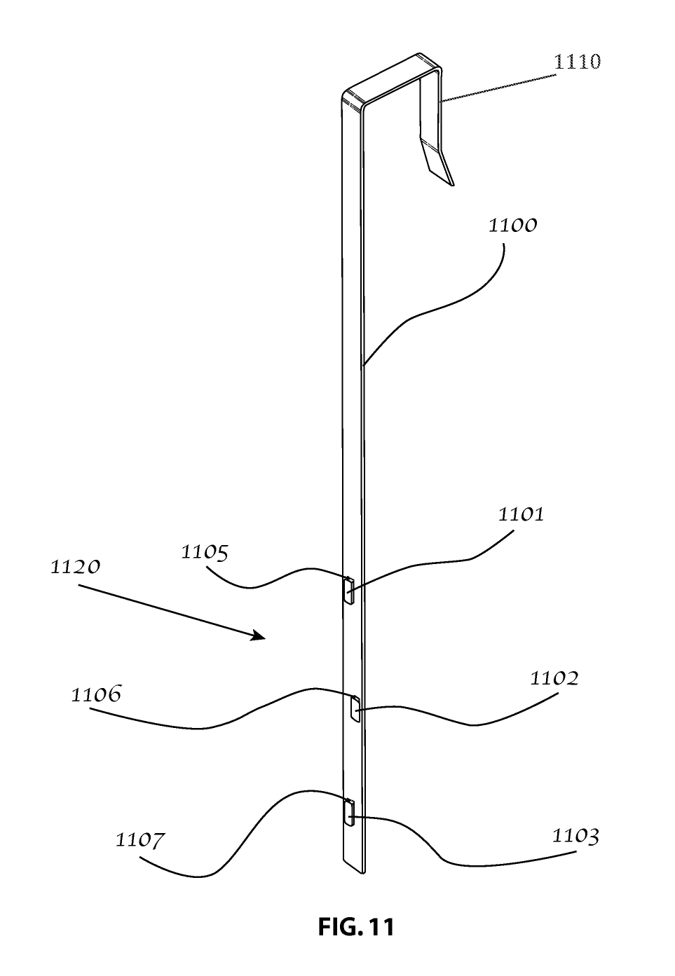

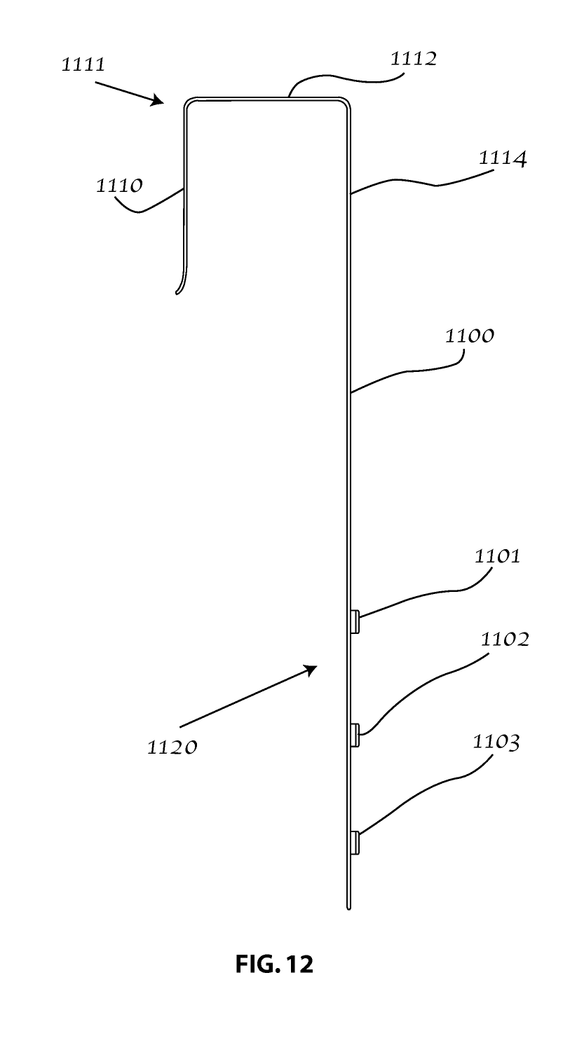

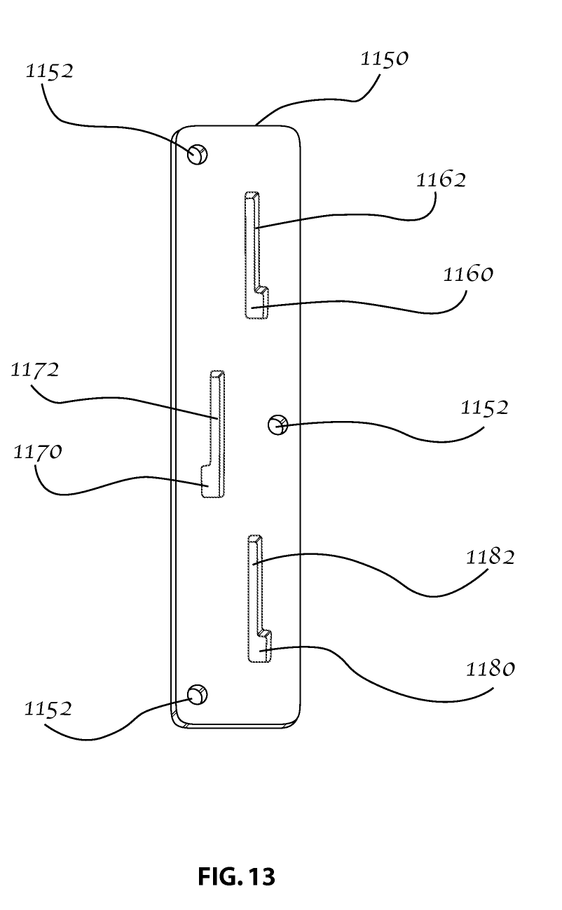

FIG. 10 is an illustration of a perspective view of the bracket of another embodiment of the hanger. The door hook 800 shown in FIGS. 8 and 9 is preferably engageable with interlock plate 950. As shown in FIG. 10, the interlock plate 950 is preferably comprised of one or more apertures 960 and 970, one or more sliding apertures 962 and 972, and one or more securing apertures 952. Preferably, the tabs 901 and 902 matingly pass through apertures 960 and 970 and then slidingly lock into place down sliding apertures 962 and 972.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A device for hanging an object over a door comprising:
a door hook; and
an interlock plate;
wherein said door hook is comprised of an upper bracket and an interlock plate engagement portion;
wherein said upper bracket is configured to engage a top of a door such that said door supports said door hook;
wherein said interlock plate engagement portion is comprised of one or more apertures;
wherein said interlock plate is configured to engage with an object and is comprised of one or more interlock clips;
wherein said one or more interlock clips are configured to matingly engage with said one or more apertures of said interlock plate engagement portion.

2. The device for hanging an object over a door of claim 1, wherein said interlock plate is further comprised of one or more securing apertures.

3. The device for hanging an object over a door of claim 1, wherein said one or more interlock clips extend outward from said interlock plate, such that when said interlock plate engages with said interlock plate engagement portion, at least one of said one or more interlock clips pass through at least of said one or more apertures of said interlock plate engagement portion.

4. The device for hanging an object over a door of claim 1, wherein said object is a mirror.

5. The device for hanging an object over a door of claim 1, wherein said object is an object selected from the group of objects consisting of a toiletry kit, a shoe rack, a tie rack, and a suit rack.

6. The device for hanging an object over a door of claim 1, wherein there are three apertures on said interlock engagement portion; and
wherein there are three interlock clips on said interlock plate.

7. A device for hanging an object over a door comprising:
a door hook; and
an interlock plate;
wherein said door hook is comprised of an upper bracket and an interlock plate engagement portion;
wherein said upper bracket is configured to engage a top of a door such that said door supports said door hook;
wherein said interlock plate engagement portion is comprised of one or more apertures;
wherein said interlock plate is configured to engage with an object and is comprised of one or more interlock clips;
wherein said interlock plate is further comprised of one or more securing apertures;
wherein said interlock plate engages with said interlock plate engagement portion;
wherein said one or more interlock clips extend outward from said interlock plate, such that when said interlock plate engages with said interlock plate engagement portion, at least one of said one or more interlock clips pass through at least of said one or more apertures of said interlock plate engagement portion, such that said one or more interlock clips matingly engage with said one or more apertures of said interlock plate engagement portion.

8. The device for hanging an object over a door of claim 7, wherein said object is a mirror.

9. The device for hanging an object over a door of claim 7, wherein said object is an object selected from the group of objects consisting of a toiletry kit, a shoe rack, a tie rack, and a suit rack.

10. The device for hanging an object over a door of claim 7, wherein there are three apertures on said interlock engagement portion; and
wherein there are three interlock clips on said interlock plate.

11. A device for hanging an object over a door comprising:
a door hook; and
an interlock plate;
wherein said door hook is comprised of an upper bracket and an interlock plate engagement portion;
wherein said upper bracket is configured to engage a top of a door such that said door supports said door hook, and said upper bracket is comprised of a front, a top, and a back;
wherein said interlock plate engagement portion is comprised of one or more apertures and said interlock plate engagement portion is an extension of said back of said upper bracket;
wherein said interlock plate is configured to engage with an object and is comprised of one or more interlock clips;
wherein said one or more interlock clips are configured to matingly engage with said one or more apertures of said interlock plate engagement portion.

12. The device for hanging an object over a door of claim 11, wherein said interlock plate is further comprised of one or more securing apertures.

13. The device for hanging an object over a door of claim 11, wherein said one or more interlock clips extend outward and downward from said interlock plate, such that when said interlock plate engages with said interlock plate engagement portion, at least one of said one or more interlock clips pass through at least of said one or more apertures of said interlock plate engagement portion, and wherein said interlock plate slides downward such that said interlock plate and said object that is secured to said interlock plate are supported by said door hook.

14. The device for hanging an object over a door of claim 13, wherein said object is a mirror.

15. The device for hanging an object over a door of claim 13, wherein said object is an object selected from the group of objects consisting of a toiletry kit, a shoe rack, a tie rack, and a suit rack.

16. The device for hanging an object over a door of claim 13, wherein there are three apertures on said interlock engagement portion; and
wherein there are three interlock clips on said interlock plate.
